(19) United States
(12) Patent Application Publication
(10) Pub. No.: US 2018/0165097 A1
(43) Pub. Date: Jun. 14, 2018

(54) DISPATCH OF PROCESSOR READ RESULTS

(71) Applicant: Palo Alto Research Center Incorporated, Palo Alto, CA (US)

(72) Inventor: John Hanley, Emerald Hills, CA (US)

(73) Assignee: Palo Alto Research Center Incorporated, Palo Alto, CA (US)

(21) Appl. No.: 15/378,585

(22) Filed: Dec. 14, 2016

(51) Int. Cl. G06F 9/38; G06F 9/30; G06F 12/084; G06F 12/0842; G06F 12/14

(52) U.S. Cl. CPC G06F 9/3836; G06F 9/3012; G06F 9/3867; G06F 9/3009; G06F 2212/62; G06F 12/0842; G06F 12/14; G06F 2212/1052; G06F 12/084

(57) ABSTRACT

In a multi-core, multi-tenant computing environment a shared cache is removed, and that space on the silicon of a CPU chip is designed to include a static register file scratchpad that is visible to the system security software. Such a static register file may be explicitly managed, where its security properties can be reasoned about via the system security software. Alternatively, a portion of the silicon is provided for a shared cache and the remainder of the space (silicon) is used for the static register file scratchpad. The proposed design, architecture and operation also includes a thread dispatch arrangement that lets the CPU architecture which uses the static register file scratchpad alone or in combination with a shared cache to continue to do useful work even in the presence of high read latency components.

### BACKGROUND

The present disclosure relates to multi-core multi-tenant computing systems, and system architecture, design and operation. More particularly, it is directed to computing securely in multi-core multi-tenant environments, and to computing quickly, even when the system includes memory such as random access memory (RAM) chips which have high read latency. It is understood that multi-core herein refers to a single computing component with at least two independent physical processing units (i.e., cores) that read and execute program instructions (of for example a software application), and that multi-tenant refers to a single computer server, servicing multiple tenants (e.g., users) sharing a common access with specific privileges to the server.

Existing chip sets are designed to include cache features to mask read latencies, allowing quick computation by central processing units (CPUs) having multiple processing cores. The expense of cache commonly motivates designers to include a cache that is shared amongst more than a single processing core. Herein this is called the last cache level, L2. It is understood however that in certain designs the shared cache may be another cache level, such as but not limited to designs incorporating one or more intermediate caches (e.g., intermediate caches L2, L3, and L4, with a shared last-level cache of L5).

An issue that exists with architectures which share cache among processing cores is that the shared cache will often unintentionally and, substantially invisibly to system security software, maintain detectable traces of information for a significant amount of time during processing or after processing has been completed. This is a particularly important issue when such information is sensitive, private and/or privileged. During this time period the information (e.g., victim process computations) will be potentially accessible to an unprivileged spy process (e.g., a hacker may be able to obtain this information and/or use this information to gain access the computing operations of the mentioned user).

A particular example where the shared cache architecture makes the computing system vulnerable is when a spy process is using a timing attack on the computing system. One such situation is when a bank computing system is transferring money. In this process it is intended that such a transfer is taking place in a private secure manner. However, an appropriate timing attack permits a spy process in the multi-core multi-tenant environment to gain access to privileged information which could lead to theft from the bank and/or the bank's customer. Timing attacks are possible in certain situations due to the existence of the shared cache. Details of timing attacks are thoroughly described in the existing literature [DJB 2005]. Citation: Cache-timing attacks on AES, Daniel J. Bernstein, http://cr.yp.to/antiforgery/cachetiming-20050414.pdf

Therefore, at present, secure computation in multi-core, multi-tenant compute environments is not available.

The transmission of the intended secured transactions, (e.g., the money transfer example) commonly takes place in multi-core, multi-tenant computer environments.

In view of the above, the present disclosure teaches the altering of existing CPU computing system design and architecture to eliminate or decrease vulnerability of multi-core multi-tenant environments, and for such a revised CPU architecture to provide techniques that allow such computing systems to rapidly do useful work, even with the presence of high read latency components.

### BRIEF DESCRIPTION

A system and method of improving security and performance by rapidly dispatching processor read events.

The disclosure includes a computer system and method providing a plurality of processing cores; a static register file scratchpad configured with a plurality of memory locations, the plurality of memory locations divided into a plurality of non-overlapping sets of memory locations, each of the sets of memory locations assigned by system security software; a system memory; and a memory controller in operational association with the system memory, and the static register file scratchpad, wherein the processing cores are configured to include a dispatch instruction address in read requests issued by the processing cores, the dispatch instruction address being used to resume operation of an associated application once a read operation associated with a read request is completed.

The computer system and method further includes a shared cache, wherein an application operating in the computer system is configured to optionally bypass the shared cache.

The computer system and method further includes configuring the memory controller to pass along a dispatch instruction address in read requests issued by the processing cores.

The computer system and method further includes configuring the system memory to pass along a dispatch instruction address in read responses generated in response to read requests issued by the processing cores.

The computer system and method further includes configuring the processing cores to accept a dispatch instruction address in a read response, and to add the dispatch instruction address to a local thread queue, and subsequently load the dispatch instruction address into a program counter (PC) of an associated processing core in response to one of a HALT event or a STALL event.

The computer system and method further includes having access by the processing cores to the static register file scratchpad configured to be controlled by system security software.

The computer system and method further includes an instruction pipeline supporting a first hyper-thread and a second hyper-thread; and one of the processing cores of the plurality of processing cores, being in operative association with the first hyper-thread and the second hyper-thread, the first hyper-thread configured to process instructions of a first application thread for the one processing core of the plurality of processing cores and the second hyper-thread further configured to process instructions of a second application thread for the one processing core of the plurality of processing cores, and wherein when the first application thread is in an idle or stalled state that has stopped processing of instructions of the first application thread, the second hyper-thread is configured to process instructions of a second application thread for the one processing core of the plurality of processing cores.

The computer system and method further includes having the first hyper-thread configured to process instructions of the first application thread when the second application thread is in an idle or memory stall state.

The computer system and method further includes having the instruction pipeline supporting the first hyper-thread and the second hyper-thread in operational association with the static register file scratchpad.

The computer system and method further includes having a compiler designed to permit dynamic resizing of the static register file scratchpad.

### BRIEF DESCRIPTION OF THE DRAWINGS

FIG. 1 illustrates a central processing unit architecture including a shared cache.

FIG. 2 illustrates a move instruction which may be used in conjunction with the CPU architecture of FIG. 1.

FIG. 3 illustrates CPU architecture which removes the shared cache memory, which is replaced by a static register file scratchpad;

FIG. 4 illustrates code for a revised example of the move instruction which may be used in conjunction with the revised architecture of FIG. 3;

FIG. 5 illustrates an alternative CPU architecture embodiment including both a smaller shared cache and a smaller static register file scratchpad.

FIG. 6A depicts a CPU architecture having at least two hyper-threads per core.

FIG. 6B depicts a new CPU architecture which is only limited by the size of a queue memory.

FIG. 7 illustrates code for a move operation which may be implemented according to the present disclosure.

FIG. 8 illustrates more complex code that moves and sums three figures and may be implemented according to the present disclosure.

FIG. 9 illustrates a computer network within which the present concepts may be employed.

### DETAILED DESCRIPTION

The following discussion discloses CPU designs and architectures, that alter existing CPUs as related at least to shared cache that is substantially “transparent” or “invisible” to system security software, and to operations (e.g., code implementations) that assist in making operation of such CPUs efficient.

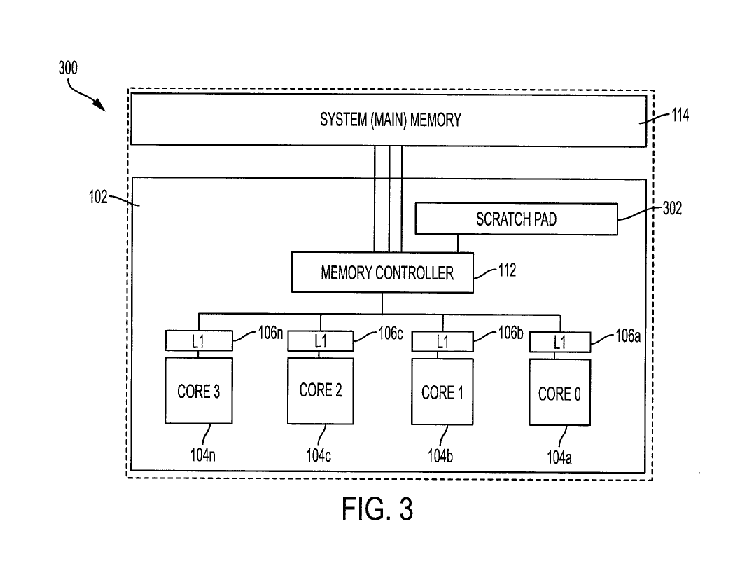

In one embodiment the shared cache has been removed and that amount, or some portion of that amount, of space on the silicon of the CPU chip is designed to include a static register file scratchpad, such as but not limited to a high-speed RAM scratchpad which is visible to the system security software. Such a static register file may be explicitly managed, where its security properties can be reasoned about (e.g., controlled, interrogated, etc.) via the system security software. An embodiment of such scratchpad architecture is depicted in FIG. 3. It is understood that cores experience very low read latency to on-chip memories, such as L1 (106a) and scratchpad (302) memories, and that cores experience very high read latency to system or main memory (114). The system memory 114 is intended to include, but is not limited to Read Only Memory (ROM), Random Access Memory (RAM), and Non-Volatile Random Access Memory (NVRAM).

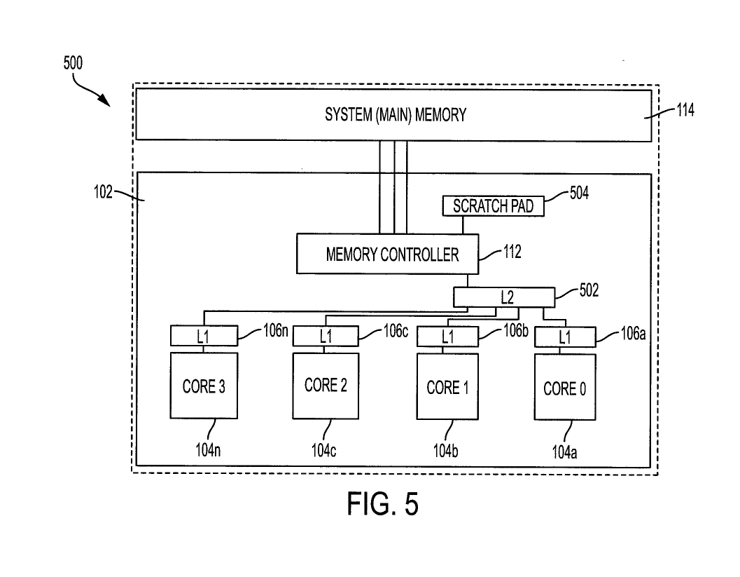

In an alternative embodiment the area of the silicon is designed to include a reduced sized shared cache and the remainder of the silicon space being used for the static register file scratchpad. This hybrid architecture is depicted in FIG. 5.

The proposed design, architecture and operation also includes a hyper-thread dispatch technique that lets the CPU with a scratchpad or hybrid architecture to continue to do useful work even in the presence of high read latency components, such as the system memory.

Implementation of the above concepts permits for more secure computation in a variety of multi-core, multi-tenant settings. For example, a desktop process may manipulate Advanced Encryption Standard (AES) keying material, at the same time that a potential spy process is running in a browser javascript sandbox, while a high level of security is maintained. Or a bank and an attacker may each contract with Amazon Web Services (AWS) or other cloud-based computing services to run their virtual machines (VM) under the same hypervisor, again without a loss of security for the bank VM. These are only two of numerous implementations where the present concepts may be employed.

Turning now more specifically to the present disclosure, it is known that the clock rates of modern CPU cores have sped up faster than corresponding rates of memory chips. In view of this situation a variety of layered caching technology has developed around the desire to keep the cores busy with useful work while masking such latencies. Existing techniques have proven effective for workloads with good locality of reference, an assumption that often holds in practice. Data and instruction caches have slightly different characteristics. The focus in the following discussion is on data caches. It is also assumed here that sensitive information may be safely stored in the per-core L1 private caches, as system software can segregate privileged sensitive high-integrity processes based on the core a given process is scheduled on. Unprivileged low-integrity processes will be scheduled on a distinct set of cores which have their own low-integrity L1 caches.

Caches incur several expenses. They add latency in the event of a cache miss. They consume power and silicon area, especially for large caches that have good hit rates. Caches may have subtle interactions with the memory management unit (MMU), also called page memory management unit (PMMU), which is computer hardware configured to primarily translate virtual memory addresses to physical addresses.

Further, the maintenance of cache memory adds both hardware and software complexity, including memory barrier delays added to applications (also called herein “app”, “apps”, or application threads, such as a first application thread, second application thread, etc.). Bandwidth is wasted by short accesses that refer to less than the 64 bytes in a cache line, and is also wasted by incorrect prefetch predictions. Additional system resources are devoted to cache coherency protocols.

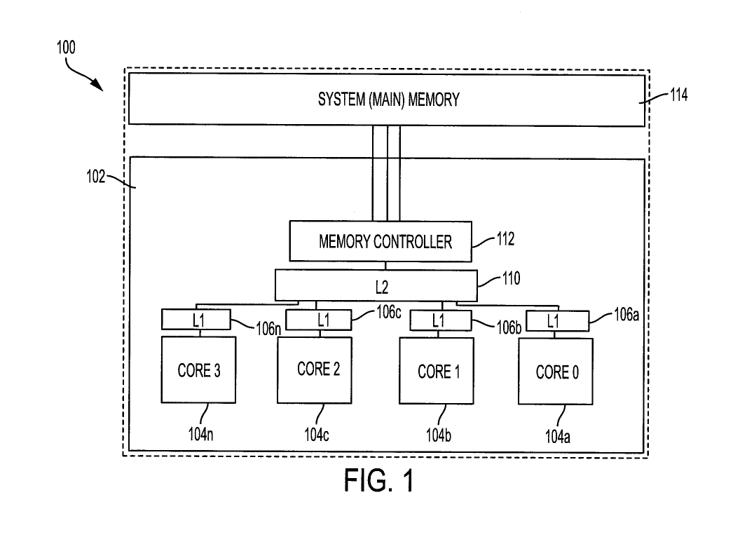

Turning to FIG. 1, illustrated is a somewhat generic depiction of a multi-core central processing unit (CPU) architecture 100, which focuses on the memory elements. Located on chip (silicon) 102 are multiple processing cores 104a, 104b, 104c, 104n. Each of the processing cores 104a-104n are in operative association with corresponding fast or first caches (L1) 106a, 106b, 106c, 106n. The L1 caches are physically and operationally isolated from the other processing cores. However another cache level (L2) is illustrated as being a shared cache 110, where each of the processing cores 104a-104n has the ability to access locations of the shared cache 108. A memory controller 112 provides functions that include allowing access to off-chip system memory 114. It is to be understood that the present teachings may be implemented in systems having additional cache levels beyond those depicted herein. It is also noted that a particular focus of the present disclosure is on whether cache resources are shared and that details of specific topology and hierarchy may vary.

The desire to minimize expenses, such as those mentioned above, motivates designs where multiple cores share last level cache (L2) 110. This design however impacts security, as L2 potentially contains traces of privileged user information (e.g., process computations) for an extended period of time, making it potentially accessible to an unprivileged spy process, or equivalently a spy VM. The concepts discussed herein are intended to address this security shortcoming.

The present discussion focuses on performance for reads, as writes can always queue up while the core continues on.

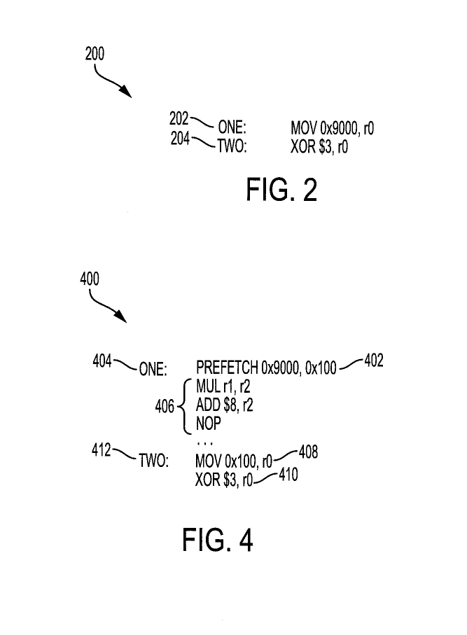

To assist in explanation, first considered are move instructions executed by a privileged process, for example as shown in FIG. 2. This instruction block 200 begins at the location labeled ONE 202, with an instruction to fetch a value from a system memory location (MOV 0x9000) and move it into register r0. Then at location TWO 204 the instruction flips the two low-order bits (XOR $3, r0). The instruction at location TWO 204 executes in a single clock cycle, while on certain hardware, the instruction at location ONE 202 stalls for twenty cycles or more as it awaits a response from system memory.

### No Shared Cache

With attention to an embodiment of the present disclosure, if in order to increase security the L2 shared cache 110 was removed from the architecture of FIG. 1, the data path between CPU cores 104a-104n and system memory 114 lacks common shared caching logic. In such a CPU architecture repeated executions of the instructions at location ONE 202 will always be slow, consuming at least twenty cycles, raising a serious performance consequence that must be resolved.

Turning to FIG. 3, a distinct computing system, such as CPU architecture 300 is illustrated which provides increased security by reclaiming the silicon area of the former L2 cache, and using it for an equally or other sized static register file scratchpad 302, such as in one embodiment in the form of low-latency on-chip RAM. The scratchpad 302 may be located in the same or different physical location of the removed full sized L2 cache. In this example addresses 0x100 through 0x1ff (or other addresses) will be part of such a static register file scratchpad 302, with those addresses statically allocated as targets of the discussed MOV instructions; by for example operating system (OS) software or hypervisor (security) system software. The plurality of memory locations are divided into a plurality of non-overlapping sets of memory locations. Each word in the static register file scratchpad is slightly wider than words in system memory, being augmented by one or more auxiliary bits that distinguishes between “read pending” and “valid”. The connections between the static register file scratchpad 302 and the components of the CPU (e.g., such as but not limited to the L1 cache and the processing cores 104a-104n) are accomplished by known techniques, similar to those used when connecting with the removed L2 cache.

In this regard a revised instruction block 400 is illustrated in FIG. 4, and is designed to operate under the architecture of FIG. 3.

More particularly, PREFETCH instruction 402 of location ONE 404 prefetches bytes from slow memory (e.g., off-chip system memory 114 of FIG. 3) at address 0x9000, moving those values to on-chip memory at 0x100 of static register file scratchpad 302. This consumes at least twenty cycles, or delay slots. To improve operation a compiler is configured to opportunistically fill these cycles or slots with unrelated work from a non-interfering data flow, performing multiplications, additions, and so on (e.g., MUL r1, r2; ADD $8, r2) 406. Eventually the memory read operation 402 completes, and a value is quickly copied (e.g., in a cycle or two) into register 0 (i.e., MOV 0x100, r0) 408 followed by an arithmetic logic unit (ALU) operation (i.e., XOR) 410 that flips two low-order bits, at location TWO 412. It is understood that as used herein, compiler program(s) is/are operating on the cores (104a-104n).

A difference here is that details of the potentially privileged computation, e.g. its access of private location 0x9000, has not leaked into a shared (e.g., global L2) cache accessible to unprivileged spy processes. As previously mentioned system software can neither control nor efficiently observe the shared cache (i.e. the removed L2) details. The present design now allows system software, with knowledge of security integrity descriptors, to statically allocate private scratchpad addresses, keeping private information private. Therefore the CPU architecture 300 of FIG. 3 removes the “shared cache” weakness from the system's security design, by use of the static register file scratchpad 302.

This design allows for quick computations, even with high latencies, and also provides secure computation. For example, core0 (104a) can rapidly access scratchpad 302 in the following manner, from core0 (104a), L1 (106a), memory controller 112, to scratchpad 302. Of course, the system memory 114 can be accessed by a slower path—core0 (104a), L1 (106a), memory controller 112 to off-chip system memory 114.

The above operations of FIG. 4 alter an existing prefetch operation, wherein previously the prefetch operation would move data to a shared cache, whereas the design is now adapted so that the operations allocate the data to a carefully allocated portion of the static register file scratchpad.

### Optional Cache

A positive aspect of caches is that they are dynamic in that they respond to different workloads. For example, assuming non-deterministic processes 1, 2, and 3 are working in a multi-core, multi-tenant environment, a shared cache (e.g., L2) can have its memory split among any of these processes to provide a useful amount of memory storage, making it a dynamically changing memory. An aspect of static allocators (e.g., the static register file scratchpad) is that much of the scratchpad space may potentially not be used due to its static nature.

Based on this understanding another embodiment of the present disclosure, a computing system, such as in the form of CPU architecture 500, is illustrated in FIG. 5. Here a smaller traditional shared L2 cache 502 is included, cut down to half the former silicon area (such as L2 110 in FIG. 1), with the remaining half of silicon area devoted to a static register file scratchpad 504. It is understood that silicon is commonly the substrate used for constructing logic circuits, but other materials may be used, as well. Of course while the above has described a split of 50-50, other proportioning between the shared L2 cache and the static register file scratchpad may be employed depending upon the operational requirements. Scratchpad 504 is constructed similar to scratchpad 302 of FIG. 3, including having each word being slightly wider than words in the system memory 114, as such words are augmented by one or more auxiliary bit or bits used to distinguish between “read pending” and “valid”.

Also, the connections between the reduced shared cache 502 and the other components of the CPU (e.g., such as but not limited to the L1 caches 106a-106n and the processing cores 104a-104n), as well as the connections between the static register file scratchpad 504 and the other components of the CPU (again e.g., such as but not limited to the L1 caches and the processing cores) are accomplished by known manufacturing techniques, similar to those used when connecting the now removed full L2 cache (i.e., 110 of FIG. 1).

To assist in the implementation of the above concepts, non-caching MOVNC and PREFETCHNC instructions are introduced, which allow access to system memory without ever altering the reduced-size shared L2 cache 502. Processes (operating, for example, on processing cores 104a-104n) handling cryptographic keys or other sensitive material may choose to use “NC” type instructions with the static register file scratchpad (302, 504) to optionally bypass the L2 cache if leaking information via the global L2 cache would be problematic. The MOVNC and PREFETCHNC instructions are similar to the existing MOV and PREFETCH instructions, but are configured to bypass the global last-level shared cache. So the “NC” portion of these instructions is intended to represent: “No Cache”. The data value shall not appear in the public shared cache, it will only be stored in a core's private L1 cache. Read latencies for MOVNC and PREFETCHNC instructions substantially match the latencies of ordinary reads which miss in the L2 cache. Writes from the MOVNC instruction always go to system memory, without affecting L2 cache contents at all.

It is to be appreciated that while MOV(NC) and PREFETCH(NC) instructions have been a focus of this discussion, it is to be understood the concepts disclosed herein are not limited to these instructions, rather the concepts are applicable to any other relevant instructions.

The embodiment of FIG. 5, which contains both the reduced shared cache L2 502 and the reduced static file scratchpad 504, permits for certain flexibility in the operation of processes of an application being run. Particularly, if part of the application is operating on sensitive data the application can be constructed and compiled such that the operations associated with the sensitive information only employ the instructions for the reduced static file scratchpad 504 (e.g., the “NC” instructions). This design will heighten security of the application. However, operations of the application dealing with non-sensitive information could be constructed to employ the reduced shared L2 cache, thereby increasing the speed of operation of the application, and improving compatibility with unmodified traditional non-secure software implementations.

### Smaller Cache Predicts Higher Miss Rate

For many workloads and access distributions, cutting effective cache size will impact cache hit rates and observed timings. Statically segregating fast memory resources at compile time into N slices (e.g., N=2 for browser javascript+banking) leaves just 1/Nth the memory for a given application, independent of concurrent workload. The following discloses two ways for the disclosed CPU architecture to be used to mitigate the impact.

Considered first is a traditional commodity CPU, with a workload of just a single application. It will allocate the entire cache, filling it with its own data. Then when it is joined by a second concurrent application, in steady state each of the two competing applications will converge to an allocation of about half the cache. Additional concurrent applications may arrive, and in general for N similar applications each gets roughly 1/Nth of the cache. Behavior of observed runs will be a bit more refined than that, since some applications will have a larger memory footprint than other applications, and these larger working set applications obtain a somewhat larger fraction of the cache, which is beneficial for system throughput.

Now with consideration to the static register file scratchpad arrangement which has been disclosed as an alternative to shared cache (e.g., in one instance in order to provide increased security). In one embodiment for such a system, at compile time an application (e.g. such as but not limited to one using the OpenSSL library) is instructed to expect exclusive access to ¼ of the static register file scratchpad, which would let the scheduler safely run up to three similar applications concurrently. This arrangement, however, artificially limits how much high-speed memory the applications can use, causing three-fourths of the static register file scratchpad to needlessly be idle when only the first application is operating.

### Compiler Produces Variants for Different Runtime Conditions

In consideration of the above and for further discussion it is assumed the compiler is instructed to produce more than one version of the object code for a particular application. For example in the first code the operating system (OS) software grants access to just ¼ of the static register file scratchpad and in a variant or second version of the code the OS software grants access to ½ the static register file scratchpad memory. This can be accomplished:

(1) by producing different object files which impose different size memory footprints (e.g., named “app-big.o”, for the larger memory footprint and “app-small.o”, for the smaller memory footprint), or

(2) by inserting conditional branches (“if” statements) in the code.

The first option (e.g., 1) is simpler and less dynamic than the second option (e.g., 2) since the chosen application (i.e., either “app-big.o” or “app-small.o”) won't be able to expand if other applications drop out, and the operating system (OS) software will not be able to shrink an application to let it continue running alongside newly arrived concurrent applications. That is, the first option is not resizable during a process's operational lifetime.

In the second option (2) there is somewhat more flexibility in that the code is designed to include an “if” statement that will determine how much of the memory footprint may be used (e.g., if the system is largely idle then one half (½) the static register file scratchpad may be used by this application; or e.g., if 2 other running applications are detected then perhaps one quarter (¼) of the static register file scratchpad may be used by this application, with allocations and access control enforced by the OS software). The kernel (i.e., the central portion of a computer's OS software, which has control over scheduling, memory allocation, and memory mapping access controls) makes the required decision when the application launches, however once the application has been launched, then the operational structure is set so its allocation will not change.

Another embodiment in this regard provides a more dynamic resizing of the static register scratchpad for long lived processes which run for longer than one second, similar to the manner in which shared caches adjust to changing workloads induced by long lived processes. Specifically, the OS software monitors memory use and may allocate additional page(s) of static register file scratchpad memory to an already running application. This is a straightforward task which mirrors what a demand pagefault handler already does routinely, e.g., as performed in the memory module unit (MMU); also called paged memory management unit (PMMU). Once the additional memory is added the application is notified of the higher memory bound. The notification is accomplished, in one embodiment, by writing to the memory location where the application stores the current scratchpad upper bound value.

In an opposite process for this embodiment, where the OS software reclaims scratchpad memory (i.e., reduces the allocated scratchpad memory) available to a particular application, this task is accomplished by undertaking the following sequence of actions:

First, the application of interest is de-scheduled so it does not run during these changes. Execution is paused for long enough that all of the application's outstanding read requests from system memory have been satisfied.

Second, page table entries of the memory module unit (MMU) are adjusted to un-map the page(s) being reclaimed;

Third, the application is notified of its reduced memory, in one instance by overwriting an upper bound value as discussed above.

Fourth, the application is rescheduled. Thereafter the application continues running, but a higher fraction of its read requests will incur a memory stall (i.e., due to the reduced available scratchpad memory).

In certain embodiments performance counters maintained by the compiler generated code help inform OS software for scratchpad allocation decisions. Thus in this embodiment an application determined by the performance counters to be experiencing a high or low rate of misses can be prioritized for expanding or shrinking the scratchpad memory allocation for that particular application.

### Read Dispatch

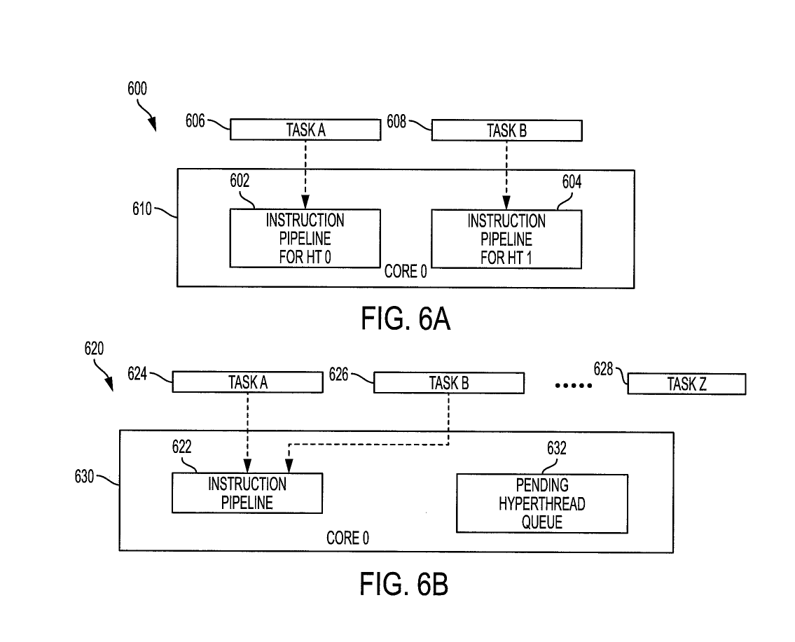

It is beneficial to keep the cores in a multi-core environment busy with useful work (i.e., it is desirable to minimize empty cycles and memory stalls). Keeping the cores at a high rate of use is an issue due to the previously discussed mismatch between fast CPU cycle times and sluggish read latencies from a system memory. An approach to dealing with this challenge can be implemented in considered CPUs that offer at least two hyper-threads per core as illustrated by the high level view of a hyper-thread design 600 of FIG. 6A. It is to be understood that layout of FIG. 6A is in certain embodiments integrated with the architectures of FIGS. 3 and 5, wherein the hyper-threads of FIG. 6A are in operational arrangement or association with the memory of these figures (e.g., the fast caches 104a-104n, as well as the static register file scratchpad 302, 504, and/or the reduced sized shared (L2) cache 502.

Recognizing that read stalls (also called memory stalls) are inevitable, in a traditional hyper-thread design a similar amount of silicon area devoted to a first instruction (e.g., to fetch/decode/execute) pipeline provides for an alternate or second instruction pipeline, to process instructions. In FIG. 6A these are identified as first Hyperthread-0 (HT-0) 602 and second Hyperthread-1 (HT-1) 604, to support hyper-threading operations which handle distinct tasks (e.g., Task A of a first application thread) 606 and (e.g., Task B of a second application thread) 608 for a same common processing core (e.g., Core 0) 610. In operation, while HT-0 is stalled, HT-1 keeps much of the processing core's remaining logic usefully busy, so it appears the arrangement has the processing power of almost two processing cores. Of course when HT-1 is stalled then HT-0 works to keep processing core 610 busy.

In contrast, the disclosed invention relies on a queue of instruction dispatch addresses, rather than instruction pipelines replicated on the silicon or other substrate, to keep the core busy despite long memory read latencies. Such a layout is more particularly shown by layout design 620 of FIG. 6B, which includes instruction pipeline 622, task A 624, task B 626 through task Z 628, core0 630, and a pending hyper-thread queue 632. In design 620 the number of tasks (e.g., task A 624, task B 626 through task Z 628) issuing reads and awaiting responses are only limited by the size of queue 632. In that regard, the drawings are noted to not be to scale and it is to be understood that where each pending task of design 600 of FIG. 6A needs a very large amount of silicon for replicated instruction fetch/decode/execute pipelines, each pending task in the layout design 620 of FIG. 6B consumes a much smaller amount of silicon (e.g., in one embodiment, an amount needed is only 64 bits). It is also noted that the layout design 620 of FIG. 6B is in certain embodiments integrated with the architectures of FIGS. 3 and 5, as mentioned in connection with FIG. 6A.

It is to be understood that in addition to memory stalls, there are also HALT or idle actions. A memory stall will end when a memory read response is delivered, while an idle corresponds to a processing thread voluntarily determining it has finished and it has no more work to do. Both stall and idle events mean the processing core should schedule some other thread from a queue. Herein the use of stall will encompass the idea of an idle state and idle will encompass a stall state, at least as to a processing core looking to schedule another thread.

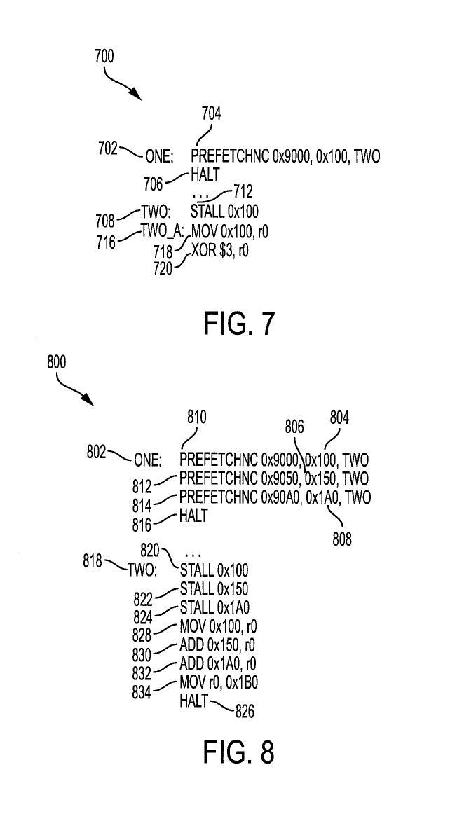

In a particular embodiment, prefetch instructions arrange for dynamic hyper-thread dispatch and they take an additional argument: a dispatch instruction address. Also introduced in this embodiment is the pending hyper-thread queue 632, and a new STALL guard instruction (see FIGS. 7 and 8). The present concepts also rely on frequently issuing HALT instructions. These above concepts will now be discussed in more detail in connection with instruction block 700 of FIG. 7 and instruction block 800 of FIG. 8. The queue 632 contains instruction dispatch addresses, and it may be a first-in-first-out (FIFO) queue or other appropriate storage.

In instruction block 700 of FIG. 7, at location ONE 702, the auxiliary bit of scratchpad location 0x100 is set to “read pending”, a read request is issued (PREFETCHNC 0x9000, 0x100, TWO) 704, where TWO is the dispatch instruction address. Then a HALT instruction 706 is issued to halt operation of the core for approximately twenty cycles, assuming no other threads are pending. Eventually the read response arrives, causing the core to resume processing at location TWO 708. The compiler-generated STALL instruction 712 interrogates the same scratchpad auxiliary bit that was set above. If it were to report “read pending” then the instruction would have the effect of a HALT, de-scheduling the current hyper-thread. In this example code the bit is guaranteed to report “valid” (as the only read instruction has been completed) so execution continues to location TWO_A 716 with a scratchpad read (MOV 0x100, r0) 718 and an ALU operation (XOR $3, r0) 720. In this example, the STALL guard instruction 712 was not strictly necessary, as the instructions could just as well have dispatched directly to location TWO_A 716.

Turning to FIG. 8, illustrated is a more complex instruction block 800 that sums three figures. At location ONE 802, three scratchpad auxiliary bits are set to “read pending” at scratchpad locations 804, 806, 808 and three read requests are issued in parallel by the PREFETCHNC instructions 810, 812, 814, which include the dispatch instruction address TWO. Then HALT instruction 816 consults the pending hyper-thread queue (e.g., 320 of FIG. 6B). If it finds a pending thread it resumes with the program counter (PC) at that location of the pending thread. Otherwise operation of the processing core is halted, as there is nothing to do, and the system is stalled (e.g., in some situations for nearly twenty cycles).

Read responses may arrive asynchronously in any random order, for example due to locations being on different memory pages or due to contention from other processing cores. Eventually a response arrives and is appended to the queue (e.g., 632 of FIG. 6B). When the core is HALTed it will accept the response from the queue, launch a new hyper-thread by loading the program counter (PC) with the indicated dispatch instruction address of location TWO 818, and execute a series of STALL guards 820, 822, 824. When a first read is received all the necessary “valid” bits will not be set, so a STALL will simply HALT 826 operations, permanently killing that hyper-thread. Subsequently a second response arrives, similarly setting a second auxiliary scratchpad bit and HALTing. When a third response arrives, all three bits are marked “valid”, so the STALL guards are satisfied and the instruction block continues execution, computing a sum of three values 828, 830, 832, and storing the result 834.

Executing in one hyper-thread the described embodiment arranged for creation of three hyper-threads before terminating the original, then created and terminated a pair of partial result hyper-threads before computing the sum and storing the result, after which the process is halted. Thus, a queue of hyper-thread dispatch instruction addresses is maintained for hyper-thread scheduling, and the dispatch instruction addresses in the queue appear in responses coming back from system memory. It is also taught the processing cores are configured to accept a dispatch instruction address in a read response, and are further configured to substantially immediately add such a dispatch instruction address into a program counter (PC) of an associated processing core in response to one of a HALT event or a STALL event, removing said dispatch instruction address from the queue.

Compiler generated and stored code is responsible for maintaining this global invariant: all memory values read by a basic instruction block shall be available in the scratchpad before execution begins. Basic blocks may begin with one or more STALL instructions to ensure this.

In the embodiment of FIG. 5 the shared (global) L2 cache 504 would be available to this privileged process, but since the program was designed to not use it, thus it was ensured the application did not leak details of its computation. By this design computations were performed quickly, even with high latencies, and were computed securely. Additionally, with the number of pending hyper-threads limited only by FIFO size, higher core utilizations may be achieved than achievable by current state of the art processors.

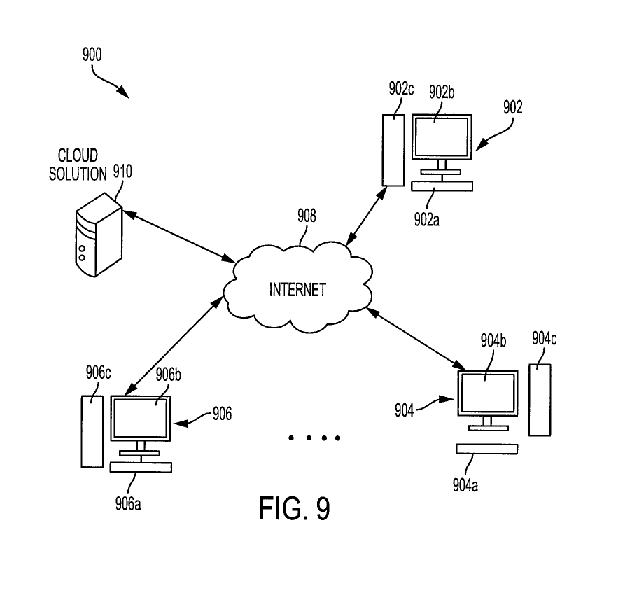

Turning to FIG. 9 illustrated is one embodiment of a multi-core, multi-tenant environment computer network 900 within which, among others, the present concepts can be employed. Particularly, a plurality of computer systems 902, 904, 906 are shown having access to the Internet 908. Also shown is a cloud solution 910, which the computing systems 902, 904, 906 may reach via the internet 908. The computing systems are further shown to have input/output components 902a, 904a, 906a, display devices 902b, 904b, 906b, and servers 902c, 904c, 908c. These computing systems have all the hardware, software, and firmware necessary to incorporate the teachings of FIGS. 2-8 for the environment of FIG. 9, both for wired and wireless operation. It is also understood the computer systems may be in the form of any appropriate computing arrangement including but not limited to desktop computers, laptop computers, tablets, smart phones, and ubiquitous computing systems among others. Further while only a few computing systems are shown it is understood the environment of FIG. 9 may include thousands to millions of such systems.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer system comprising:
a plurality of processing cores;
a static register file scratchpad configured with a plurality of memory locations, the plurality of memory locations divided into a plurality of non-overlapping sets of memory locations, each of the sets of memory locations assigned by system security software;
a system memory; and
a memory controller in operational association with the system memory, and the static register file scratchpad,
wherein the processing cores are configured to include a dispatch instruction address in read requests issued by the processing cores, the dispatch instruction address being used to resume operation of an associated application once a read operation associated with a read request is completed.

2. The computer system according to claim 1 further including a shared cache, wherein an application operating in the computer system is configured to optionally bypass the shared cache.

3. The computer system according to claim 1 further including configuring the memory controller to pass along a dispatch instruction address in read requests issued by the processing cores.

4. The computer system according to claim 1 further including configuring the system memory to pass along a dispatch instruction address in read responses generated in response to read requests issued by the processing cores.

5. The computer system according to claim 1 further including configuring the processing cores to accept a dispatch instruction address in a read response, and to add the dispatch instruction address to a local thread queue, and subsequently load the dispatch instruction address into a program counter (PC) of an associated processing core in response to one of a HALT event or a STALL event.

6. The computer system according to claim 1 wherein access by the processing cores to the static register file scratchpad is configured to be controlled by system security software.

7. The computer system according to claim 1 further including:
an instruction pipeline supporting a first hyper-thread and a second hyper-thread; and
one of the processing cores of the plurality of processing cores, being in operative association with the first hyper-thread and the second hyper-thread, the first hyper-thread configured to process instructions of a first application thread for the one processing core of the plurality of processing cores and the second hyper-thread further configured to process instructions of a second application thread for the one processing core of the plurality of processing cores, and wherein when the first application thread is in an idle or stalled state that has stopped processing of instructions of the first application thread, the second hyper-thread is configured to process instructions of a second application thread for the one processing core of the plurality of processing cores.

8. The computer system according to claim 7 wherein the first hyper-thread is further configured to process instructions of the first application thread when the second application thread is in an idle or memory stall state.

9. The computer system according to claim 7 wherein the instruction pipeline supporting the first hyper-thread and the second hyper-thread are in operational association with the static register file scratchpad.

10. The computer system according to claim 7 further including a compiler designed to permit dynamic resizing of the static register file scratchpad.

11. A computer system comprising:
an instruction pipeline supporting a first hyper-thread and a second hyper-thread;
one of a plurality of processing cores to which the instruction pipeline and the first hyper-thread and the second hyper-thread are in operational association, the first hyper-thread configured to process instructions of a first application thread for the one processing core of the plurality of processing cores and the second hyper-thread configured to process instructions of a second application thread for the one processing core of the plurality of processing cores when the first application thread is in a stalled state that has stopped processing of instructions of the first application thread, the second hyper-thread configured to process instructions of a second application thread for the one processing core of the plurality of processing cores; and
a queue of thread dispatch instruction addresses for thread scheduling, wherein the dispatch instruction addresses in the queue are from read responses coming back from system memory.

12. The computer system according to claim 11 wherein the system memory includes:
a plurality of at least first fast cache memory, each individual first fast cache memory in operational correspondence with only a specific one of the processing cores of the plurality of processing cores; and
a static register file scratchpad configured with a plurality of memory locations, the plurality of memory locations divided into a plurality of sets of memory locations, each of the sets of memory locations assigned to a specific one of the plurality of processing cores.

13. A method of operating a computer system comprising:
providing a plurality of processing cores;
providing a static register file scratchpad configured with a plurality of memory locations, the plurality of memory locations divided into a plurality of non-overlapping sets of memory locations, each of the sets of memory locations assigned by system security software;
providing a system memory;
providing a memory controller in operational association with the system memory, and the static register file scratchpad,
configuring the processing cores to include a dispatch instruction address in read requests issued by the processing cores, the dispatch instruction address being used to resume operation of an associated application once a read operation associated with a read request is completed.

14. The method of operating a computer system according to claim 13 further including providing a shared cache, wherein an application operating on the computer system can optionally bypass the shared cache.

15. The method of operating a computer system according to claim 13 further including configuring the memory controller to pass along a dispatch instruction address in read requests issued by the processing cores.

16. The method of operating a computer system according to claim 13 further including configuring the system memory to pass along a dispatch instruction address in read responses generated in response to read requests issued by the processing cores.

17. The method of operating a computer system according to claim 13 further including configuring the processing cores to accept a dispatch instruction address in a read response, and to substantially immediately add the dispatch instruction address to a local thread queue, and subsequently load the dispatch instruction address into a program counter (PC) of an associated processing core in response to one of a HALT event or a STALL event.

18. The method of operating a computer system according to claim 13 further including controlling access by the processing cores to the static register file scratchpad is by system security software.

19. The method of operating a computer system according to claim 13 further including:
providing an instruction pipeline supporting a first hyper-thread and a second hyper-thread; and
placing one of the processing cores of the plurality of processing cores in operative association with the first hyper-thread and the second hyper-thread, the first hyper-thread configured to process instructions of a first application thread for the one processing core of the plurality of processing cores and the second hyper-thread further configured to process instructions of a second application thread for the one processing core of the plurality of processing cores, and wherein when the first application thread is in a stalled state that has stopped processing of instructions of the first application thread, the second hyper-thread is configured to process instructions of a second application thread for the one processing core of the plurality of processing cores.

20. The method of operating a computer system according to claim 19 further including designing a compiler to permit dynamic resizing of the static register file scratchpad.
